(19) United States
(12) Patent Application Publication
(10) Pub. No.: US 2013/0057388 A1
(43) Pub. Date: Mar. 7, 2013

(54) Internet of Things Lawful Interception

(71) Applicant: Francesco Attanasio, Roccapiemonte (SA) (IT)

(72) Inventor: Francesco Attanasio, Roccapiemonte (SA) (IT)

(73) Assignee: TELEFONAKTIEBOLAGET LM ERICSSON (PUBL), Stockholm (SE)

(21) Appl. No.: 13/266,412

(22) PCT Filed: Sep. 5, 2011
(86) PCT No.: PCT/SE2011/051071

§ 371 Date: Oct. 26, 2011

(51) Int. Cl. G06K 7/01

(52) U.S. Cl. 340/10.1

(57) ABSTRACT

The present invention relates to methods and arrangements for providing a Law Enforcement Agency (200) with things data related to one or more target identities using a Radio-Frequency Identification (RFID) Data Manager (124), which is managing RFID data traffic comprising things data in a Radio-Frequency Data system, wherein said manager (124) is provided with an Intercepting Control Element (ICE; 160). The invention further involves receiving to the Intercepting Control Element (160) a request to intercept dynamic and optionally static things data related to one or more target identities. It further involves collecting in the Intercepting Control Element (160), dynamic things and optionally static things data related to one or more target identities for which things data has been requested and forwarding the collected data to a Law Enforcement Management Function unit.

### TECHNICAL FIELD

The present invention relates to the technical areas of Internet of Things, Radio-Frequency Identification and Lawful Interception. More specific, embodiments of a method, arrangement, computer program product and entities for providing a Law Enforcement Agency with things data are described and provided in the present specification.

### BACKGROUND

RFID (Radio-Frequency Identification) technology is a key enabler of the future Internet of Things (IOT) and it has a great economical potential.

Radio frequency identification (RFID) is a technology that allows automatic identification and data capture by using radio frequencies. The salient features of this technology are that they permit the attachment of a unique identifier and other information—using a micro-chip—to any object, animal or even a person, and to read this information through a wireless device.

RFIDs are not just “electronic tags” or “electronic barcodes”. When linked to databases and communications networks, such as the Internet, this technology provides a very powerful way of delivering new services and applications, in potentially any environment.

RFIDs are indeed seen as the gateway to a new phase of development of the Information Society, often referred to as the “internet of things” in which the internet does not only link computers and communications terminals, but potentially any of our daily surrounding objects—be they clothes, consumer goods, etc.

The original idea is based RFID-tags and unique identification through the Electronic Product Code (EPC). The Internet of Things (IoT) may add as many as 50 billion devices to the internet within a few years, many of them wireless.

The next generation of Internet applications using Internet Protocol Version 6 (IPv6) would be able to communicate with devices attached to virtually all human-made objects because of the extremely large address space of IPv6. This system would therefore be able to identify any kind of object.

Mobile RFID (Radio Frequency Identification) is a technology which uses mobile phones as RFID readers with a wireless technology and provides new valuable services to the user by integrating RFID and ubiquitous sensor network infrastructure with mobile communication and wireless internet.

FIG. 1 is a block diagram of an exemplary mobile RFID system and network according to prior art, see for instance reference 5. Said system and network is described in more detail in the section “Detailed Description” of the specification.

By examining RFID systems, it's possible to summarize the following primary entities that interact with each other:

Objects. These include all EPC-tagged objects, such as items, cases, pallets, trucks, even patients with RFID-bracelets.

Sensors/Readers. RFID readers use radio-frequency signals to communicate with EPC tags and read the EPC values. Each RFID reader (or its antenna) is also uniquely identified by its EPC code. In this document, “reader” and “sensor” are used interchangeably.

Locations. A location is symbolized to represent where an object is/was. It can be a warehouse, a retail store, a distribution center, or a route between two locations. The granularity of locations can be defined according to application needs. A location is also associated with an owner.

It has been proposed to add Lawful Interception (LI) functionality in the “Internet of Things” world in order to setup the RFID data monitoring for LI reasons and to introduce the RFID Data consolidation and RFID data centralization used for LI investigations. Lawful Intercept (LI) is the process of legally monitoring voice and data communications between parties of interest to law enforcement agencies (LEA).

FIG. 2 is a block diagram of an exemplary Lawful Interception system and network 50 according to prior art. Said system and network comprises a number of entities. The exemplary LI system comprises a Law Enforcement Management Function (LEMF) 52 for requesting LI services of the LI system and collecting the intercepted information of Intercepting Control Elements (ICEs) in the system. The system shall provide access to the intercepted Content of Communications (CC) and Intercept Related Information (IRI) of a mobile target and services related to the target on behalf of one or more Law Enforcement Agencies (LEAs). An intercept request, also denoted Request for LI activation, is sent through a first Handover Interface, HI1, located between the Law Enforcement Management Function 52 and an Intercept Mediation and Delivery Unit (IMDU) 54 comprising a Mediation Function, MF, 56 and an Administration Function, ADMF, 58. Said Mediation Function 56 and Administration Function 58 generates based on said received request a warrant comprising said one or more target identities, and sends said warrant towards an Intercepting Control Element, ICE, 60 via an interface denoted X1_1. The ICE 60 may be connected to a node of a network, e.g. a 3 GMS (third generation Mobile Communications System), from which it intercepts said Content of Communications and Intercept Related Information of a mobile target. Said CC and IRI are network related data. As reference to the standard model, see references 1, 2 and 3, the content of communication is intercepted in the ICE network node and it is based upon duplication of target communication payload without modification. In reference 3, the interfaces HI1 and HI2 is specified in more detail. The ICE sends IRI raw data via an interface X2 to a Delivery Function for IRI reporting, DF2, 64 and a Mediation Function of IRI, MF2, 62 that generates and delivers to a collection functionality a standardized IRI report based on the received IRI report. Said standardized IRI report is sent over a standardized interface HI2 to the LEMF 52. The ICE 60 also sends CC raw data via an interface X3 to a Delivery Function for CC reporting, DF3, 66 and a Mediation Function of IRI, MF3, 68 which generates and delivers to a collection functionality a standardized CC report based on the received CC report. Said standardized CC report is sent over a standardized interface HI3 to the requesting LEMF 52.

Together with the delivery functions it is used to hide from the third generation (3G) Intercepting Control Elements ICE(s) that there might be multiple activations by different Lawful Enforcement Agencies (LEA(s)) on the same target.

The HI2 and HI3-interfaces represent the interfaces between the LEA and two delivery functions. The delivery functions are used:
to distribute the Intercept Related Information (IRI) to the relevant LEA(s) via HI2;
to distribute the Content of Communication (CC) to the relevant LEA(s) via HI3.

Even though it is proposed to merge Lawful Interception (LI) functionality into the “Internet of Things” world in order to setup the RFID data monitoring for LI reasons and to introduce the RFID Data consolidation and RFID data centralization used for LI investigations, such a merge is not obvious or trivial. For instance, the actual location information Cell Group Identity/Service Area Identity (CGI/SAI) retrieved together with target telecommunication users' identities information does not allow to identify “things” but only people on which to concentrate investigation activities. There is no standard RFID data management solution for lawful interception that foresees to replace existing data silos with a single data view. It means that technologies and processes can be used to break down the barriers between the data silos to optimize use of existing “things” information, presented in the right view to the right place at the right time.

It is very likely that law enforcement agencies will ask operators and vendors to provide a technical solution for adapting lawful interception technique to mobile RFID technology.

### SUMMARY

The aim of the present embodiments is to provide different aspects that overcome the above drawbacks.

According to a first aspect, embodiments of a method are provided, said embodiments provide a Law Enforcement Agency with things data related to one or more target identities using a Radio-Frequency Identification (RFID) Data Manager, which is managing RFID data traffic comprising things data in a Radio-Frequency Data system. Said manager is provided with an Intercepting Control Element (ICE). The method involves receiving to the Intercepting Control Element a request to intercept dynamic and optionally static things data related to one or more target identities. It further involves collecting in the Intercepting Control Element, dynamic things and optionally static things data related to one or more target identities for which things data has been requested, and forwarding the collected data to a Law Enforcement Management Function unit.

According to another aspect, embodiments of an arrangement are provided, said embodiments provide a Law Enforcement Agency with dynamic things data and optionally static things data related to one or more target identities using a Radio-Frequency Identification (RFID) data Manager, which is managing RFID data traffic comprising things data in a Radio-Frequency Data system. The RFID data manager is provided with an Intercepting Control Element. The arrangement further comprises a receiver to receive to the Intercepting Control Element a request to intercept dynamic and optionally static things data related to one or more target identities. It further comprises means to collect in the Intercepting Control Element, dynamic things and optionally static things data related to one or more target identities for which things data has been requested, and a sender to forward the collected things data to a Law Enforcement Management Function unit.

According to further one aspect, embodiments of an entity are provided. Said embodiments comprise a Law Enforcement Management Function unit, comprising a sender to send a request for things data to an Intercepting Control Element and a collection functionality to receive dynamic things data and/or static things data.

According to additionally one aspect, embodiments of an entity are provided, which entity comprises a Radio-Frequency Identification (RFID) Data Manager, which is managing things data traffic in a Radio-Frequency Data system. Said RFID Data manager is provided with an Intercepting Control Element of a Lawful Interception (LI) Network.

According to another aspect, embodiments of a computer program product are provided, which computer program product comprises computer program code that is loadable into a processor, wherein the computer program comprises code adapted to perform the different embodiments of the described method when executed in the processor.

Different embodiments of the mentioned aspects above are also enclosed in the dependent claims.

One advantage with the present aspects and embodiments is that a centralized RFID Lawful Interception provides a single vendor solution that can replace several nodes in the operator network, allowing cost reductions for LI services offering and at the same time performance improvements and maximized security.

Another advantage is that the mentioned EPC code can be used as correlation item allowing aggregation of RFID Data for post-processing from Lawful agencies.

Further one advantage is the possibility to use RFID Data Manager for automatic static things data retrieval other than dynamic things data, for LI purposes.

### BRIEF DESCRIPTION OF THE DRAWINGS

The foregoing, and other, objects, features and advantages of the present invention will be more readily understood upon reading the following detailed description in conjunction with the drawings in which:

FIG. 1 is a block diagram of an exemplary Radio-Frequency Identification system and network according to prior art;

FIG. 2 is a block diagram of an exemplary Lawful Interception system and network according to prior art;

FIG. 3 is a block diagram of an exemplary arrangement in which systems and methods described herein is implemented;

FIG. 4 is a message flowchart illustrating embodiments of the present method.

FIG. 5 is a flow chart illustrating embodiments of a method for providing a Law Enforcement Agency with things data

FIG. 6 is a flow chart illustrating other embodiments of a method for providing a Law Enforcement Agency with things data.

FIG. 7 is a message flow chart illustrating embodiments of the flow of data information in the system and network arrangement.

FIG. 8 is a message flow chart illustrating other embodiments of the flow of data information in the system and network arrangement.

FIG. 9 is a block diagram illustrating an embodiment of a Law Enforcement Management Function unit, LEMF.

FIG. 10 is a block diagram illustrating an embodiment of an Intercept Mediation and Delivery Unit, IMDU.

FIG. 11 is a block diagram illustrating an embodiment of a RFID manager comprising a Intercept Controller Element.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be put into practice according to a number of embodiments that depart from the specific details of the described embodiments. In other instances, detailed descriptions of well known methods, devices, and circuits are omitted so as not to obscure the description of the present invention with unnecessary detail.

The present invention relates to the handling of things and their data, i.e. thing data. In this context, terms like “object”, “item”, and “product” could be regarded as equivalent with “thing”.

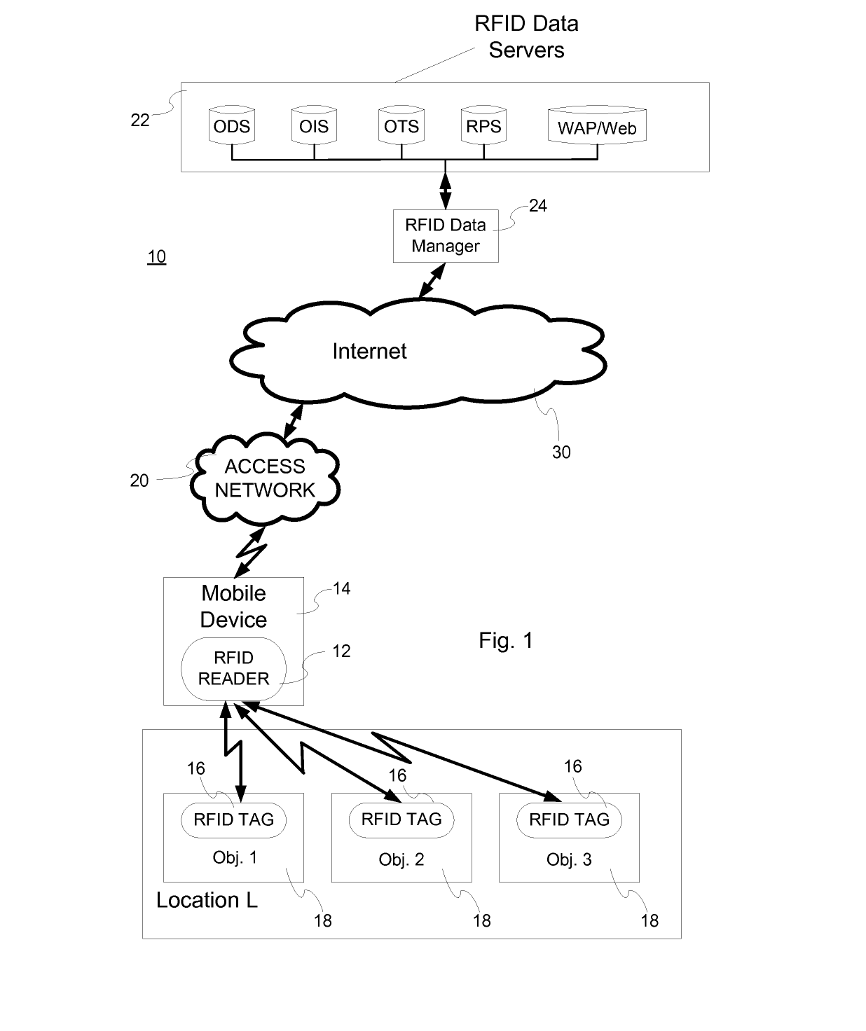

FIG. 1 is a block diagram of a Radio-Frequency Identification, RFID, system and network 10 according to prior art. Generally, an RFID system may comprise a network architecture for providing communication with a series of networks, inter-networks and globally distributed application systems, e.g. B2B (Business to Business), B2C (Business to Customer), B2B2C, G2C (Government to Customer), etc. The service infrastructure required for providing such an RFID-based mobile service involves an RFID-reader, Mobile device, communication network, network protocol, information protection, RFID data servers, RFID Data manager, and content management. Mobile RFID involves a RFID sensor or RFID reader 12 into a mobile communications device 14, e.g. mobile cell phone, etc. An example of entities of a mobile RFID service network architecture and an interface structure for the mobile RFID service's communication infrastructure is illustrated in FIG. 1. The mobile communications device 14 provides diverse services through an access telecommunications network 20 when reading RFID tags 16.

Actually, the mobile RFID communication device 14 may represent two types of mobile phone device; one is a RFID-reader-equipped mobile phone, and the other is a RFID-tag-attached mobile phone. Each type of mobile phone has different application domains: On the one hand, for example, the RFID-tag-attached type can be used as a device for payment, entry control, and identity authentication, and the main feature of this application stems from the fact that RFID readers exist in the fixed position and recognize each phone, giving the user specific services like door opening; on the other hand, the RFID reader equipped mobile phone can be utilized to provide end-users with detailed information about the tagged object through accessing the mobile wireless network.

In an RFID system, there are two basic categories of data: static data and dynamic data. Static data are related to commercial entities and product/service groups, such as location information, product level and serial level information. Dynamic data are specific to individual items.

There are two types of dynamic data: instance data such as serial number and date of manufacture, and temporal data such as observations, location and containment changes of objects, which are all captured through EPC-tag readings.

Among all the data, the temporal data are directly related to the fundamental business logic in RFID applications, such as the movement and transaction of products, and are crucial for an RFID data system to track and monitor objects.

The mobile RFID service has been defined as the provision, through a wireless Internet network 20, of personalized secure services—such as searching for product information, purchasing, verifying, and paying for products—while on move, enabled by e.g. a RFID reader chip 12 integrated with the circuitry of a cellular mobile terminal 14. RFID wireless access communication takes place between the RFID tag 16 and a cellular mobile device 14, mobile communication takes place between the mobile communication device 14 and an access network 20 (comprising BTS (Base Transceiver Station)/ANTS (Access Network Transceiver Subsystem), which is not illustrated in FIG. 1), and wire communication takes place via the access network 20 and internet RFID Data Servers 22. The RFID Data servers 22 may involve a number of servers for providing different services, e.g. ODS (Object Directory Service), OTS (Object Traceability Service), OIS (Object Information Service), RPS (RFID Privacy Management Service), and WAP (Wireless Application Protocol)/Web.

The ODS is an information system that provides data needed to obtain an information resource over a network for a specific code expressed in numbers (or mobile RFID's code). The ODS server plays the role of a DNS (Directory Name System) server which informs the mobile RFID phone of the contents/service server's location.

The OTS server keeps a record of the tag readings in the RFID readers throughout the lifecycle of the objects. Its main purpose is to track objects in the SCM (Supply Chain Management).

The OIS server records the reading of the RFIG tag event in the OTS server and may provide additional detailed information on an object—such as manufacturing time, manufacture's name, expiration time, etc.

The RPS controls access to the information on the object in accordance with the privacy profile put together by the owner of the object.

The WAP and Web servers are contents servers that provide wireless Internet contents such as news, games, music, videos, stock trading, lotteries, images, and so forth.

The mobile communication device 14 is equipped with RFID application software, here denoted as mobile RFID middleware. It may be an extension of the WIPI (Wireless Internet Platform for Interoperability) software platform to provide RF code related information obtained from an RF tag through an RFID reader installed e.g. in a cellular mobile phone. The networked terminal's function is concerned with a recognition distance to the RFID reader chip 12 built into the cellular mobile phone 14, transmission power, frequency, interface, technological standard, PIN (Personal Identification Number) specification, UART (Universal Asynchronous Receiver and Transmitter) communication interface, WIPI API (Application Program Interface) extended specification to control the reader chip. RFID reader chip middleware functions are provided to the application program in the form of mobile platform's API. The mobile RFID device 14 driver may be a device driver software provided by the reader chip manufacturer.

The mobile RFID system and network 10 function is concerned with communication protocols such as the ODS communication for code interpretation, the message transportation for the transmission and reception of contents between the mobile phone terminal 14 and the application server 22, contents negotiation that supports the mobile RFID service environment and ensures optimum contents transfer between the mobile phone terminal 14 and the application servers 22, and session management that enables the application to create and manage the required status information while transmitting the message and the WIPI extended specification which supports these communication services.

The basic communication scenario for mobile RFID service is as follows:

First, a mobile RFID communication device 14 reads the RFID tag 16 on an object 18 in a location L and fetches the code stored in it. Second, the mobile RFID communication device 14 executes the code resolution with which the mobile RFID communication device 14 obtains the location of the remote server 22 that provides information on the product or an adequate mobile service. A code resolution protocol is used and may be identical with DNS protocol used for communication with DNS servers. An ODS server operates in the similar way as a DNS server and is also similar to EPCglobal's ONS (Object Name Service) server. The mobile RFID communication device 14 directs queries on the location of the server 22 with a code to the ODS server, then the ODS server replies by giving the location of the WAP/WEB server containing requested product information. Finally, the mobile RFID communication device 14 requests contents or a service from the designated server whose location has been acquired from the ODS server.

Further, the RFID Data Management System 10 comprises a RFID Data Manager 24. It provides expressive data modeling, semantic data filtering, data aggregation, RFID object tracking and monitoring, and decision-making support. It consists of three layers: Semantic Data Processing Layer, Query Layer, and Decision-Making Layer, which could be described as follows:
Semantic Data Processing Layer. This layer provides high level semantic data processing including semantic filtering and automatic data transformation and aggregation. A rules-based framework is formalized to automate the transformation.
In order to effectively track and monitor RFID objects, the acquired data need to be automatically transformed into high level semantic data, through:
i) Data Filtering. The observations from readers may contain errors such as duplicates and have to be filtered. Data is filtered according to predefined constraints with global and domain information. For example, multiple readers can generate duplicate readings which may be filtered by means of a filter will scan data within a sliding window to find if there are duplicate EPC readings from multiple readers, and delete the duplicate if it exists;
ii) Location Transformation. RFID observations can imply change of locations and business movement, and need to be interpreted and represented. For instance, a reader may be mounted at a warehouse departure zone and is there configured to scan objects before their departure;
iii) Data Aggregation. There can be semantic relationships among RFID objects, such as containment relationships. Such relationships are implicit and have to be aggregated according to the observation patterns. Transformed data may be stored in the RFID data store. For instance, when pallets are loaded into a truck to depart, a sequence of readings on the pallets are done, followed by (with a distinctive distance) a separate reading of the truck's EPC. This sequence of events will aggregate as a containment relationship between the pallets and the truck.
   Query Layer. This layer defines methods for RFID object tracking and RFID object monitoring.
RFID object tracking is a tool that tracks the change history of an object's states and detects missing objects. There are two scenarios for Missing RFID Object Detection, the first one is “Missing RFID Object Tracking”, which object is to locate when and where an object was lost, knowing the lost object's EPC. This means that the object appeared at previous locations, but not at current location. The second scenario is “Possible Missing RFID Object Searching”, to search if there is any missing object at a certain location C, knowing that a previous location L and timestamp T, all objects where complete. This can be done by comparing the two sets of objects between location C and location L. One common query is to find how long it takes for an object to move from one location to another.
RFID Object Monitoring is a tool for monitoring the states of RFID objects and the RFID system. These include snapshot inquiry, temporal slicing inquiry, temporal join query, temporal aggregation and containment examination.
   Decision-making Layer. This layer provides business intelligence such as automatic shipping notice, low inventory alert, trend analysis, and so on.

Data generated from an RFID application can be seen as a stream of RFID tuples of the form (EPC; location; time), where EPC (Electronic Product Code) is the unique identifier read by an RFID reader 12, location L is the place where the RFID reader 12 scanned the item, and time is the time when the reading took place. Tuples are usually stored according to a time sequence. A single EPC may have multiple readings at the same location; each reading is generated by the RFID reader scanning for tags at fixed time intervals.

In order to reduce the large amount of redundancy in the raw data, data cleaning should be performed. The output after data cleaning is a set of clean stay records of the form (EPC, location, time in, time out) where time in is the time when the object enters the location L, and time out is the time when the object leaves the location L.

One key concept is location. A location can be a geographic location or a symbolic location. Here we assume a symbolic location, which can be, for instance a surgery room, a smart box, a shipping route or a warehouse. Location changes come with the movement of objects.

Data cleaning of stay records can be accomplished by sorting the raw data on EPC and time, and generating time in and time out for each location by merging consecutive records for the same object staying at the same location.

In order to setup the RFID data monitoring for Lawful Interception (LI) reasons and to introduce the RFID Data consolidation and RFID data centralization used for LI investigations, it is necessary to add Lawful Interception functionality in the “Internet of Things” world and RFID system. For instance warrants could be used for tracking and monitoring inadvertent or illegal loss of “things”.

However, a number of problems arise when trying to apply the Lawful Interception technology.

One problem is that the LI standard solution doesn't foresee the use of warrants on RFID data. The actual location information Cell Group Identity/Service Area Identity (CGI/SAI) retrieved together with target telecommunication users' identities information does not allow to identify “things” but only people on which to concentrate investigation activities.

Another problem is that there is no standard RFID data management solution for lawful interception that foresees to replace existing data silos with a single data view. It means that technologies and processes can be used to break down the barriers between the data silos to optimize use of existing “things” information, presented in the right view to the right place at the right time. Data consolidation, in addition to data centralization (aimed mainly at reducing data and network operation costs), other than data management techniques can be applied to draw maximum value from the data itself.

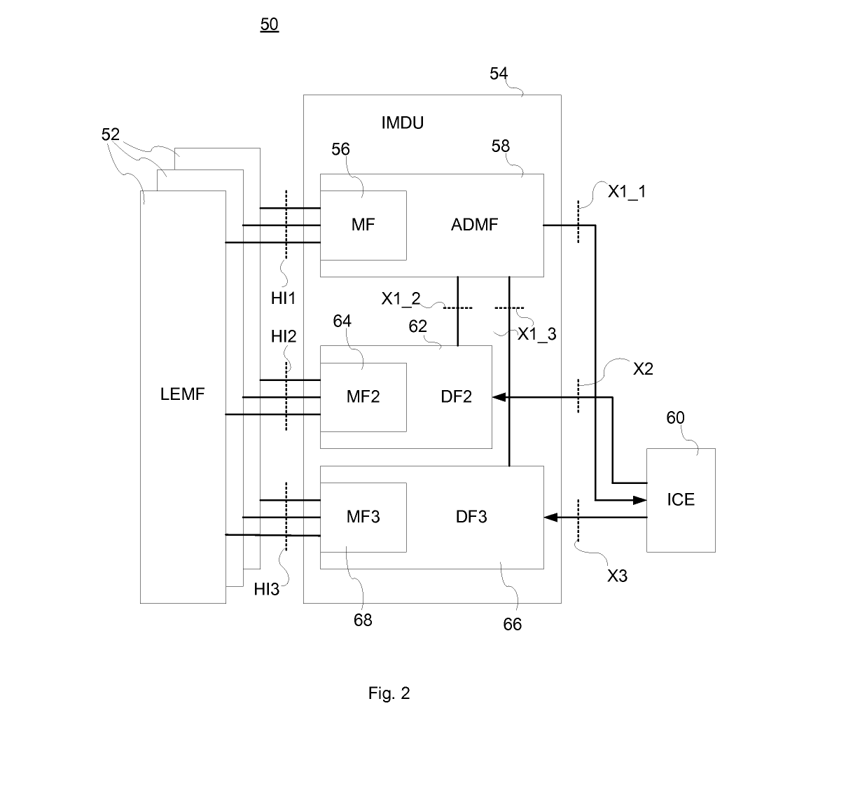

FIG. 2 is a block diagram illustrating an exemplary Lawful Interception system and network according to prior art. Said system and network comprises a number of entities, which already has been described in the background section of this specification.

As already described, it is not possible to merge a prior art RFID data management system as illustrated in FIG. 1 with a prior art Lawful Interception system as described in FIG. 2. It is therefore necessary to adapt the two systems and networks to each other.

An enhancement of the handover interfaces is proposed, allowing LEA investigators to get all RFID traffic data and relevant “THINGS” data related to target ids.

When a warrant is triggered with “get things Information” option enabled, an IRI Report containing things details related to the monitored target identity is sent from the RFID Data Manager towards the IMDU (LI Mediation System).

It means that IMDU, or LI Mediation System, shall then be able to handover to the LEMF a mediated IRI report, including all things data available, linked to a certain target identity.

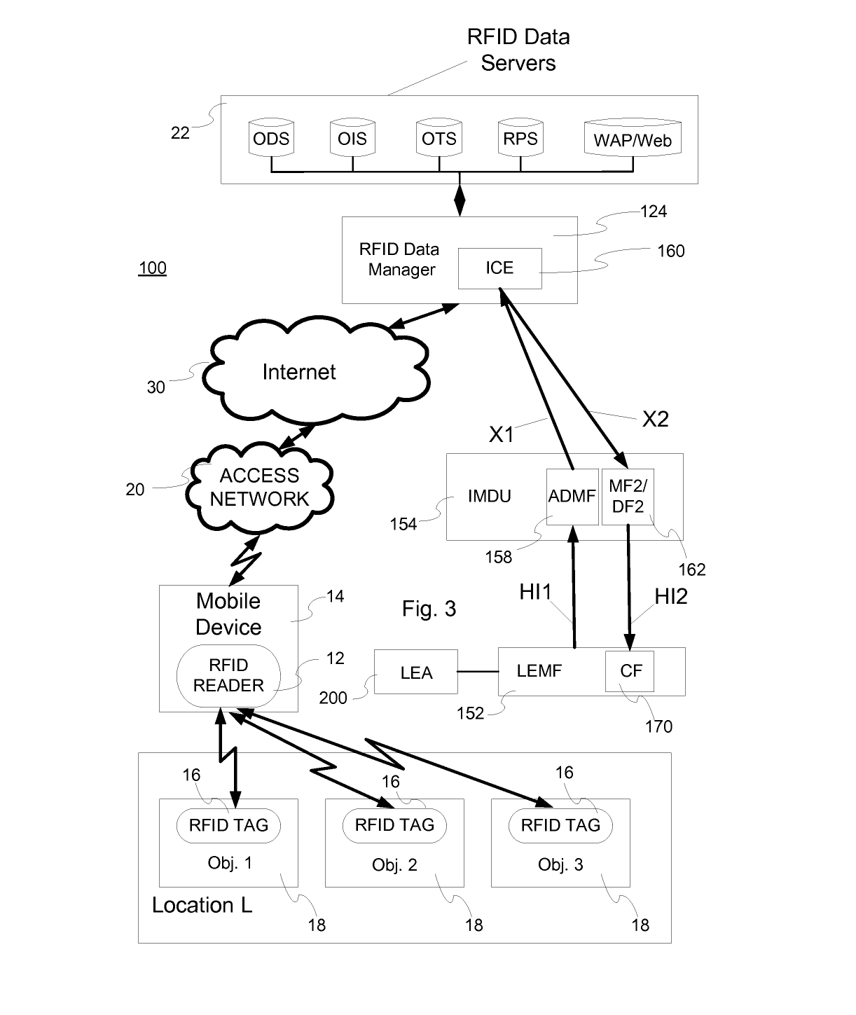

FIG. 3 is a block diagram of an exemplary embodiment of a system and network arrangement 100 comprising a mobile RFID data system interacting with a LI system. This is an arrangement that adapted to provide a Law Enforcement Agency with dynamic things data and optionally static things data related to one or more target identities wherein a Radio-Frequency Identification (RFID) Data Manager System is acting as Intercepting Control Element.

The RFID system comprises one or more mobile communication device 14, each such mobile communication device 14 comprising a RFID reader 12. Said RFID readers 12 are able to read RFID tags 16 attached to objects 18. As described above, the RFID tags stores data which is read by the RFID readers 12 and forwarded to the RFID data manager 124 and RFID Data Servers 22 via a wireless connection to an access network 20 and the Internet 30.

According to embodiments, the mobile RFID data system of the arrangement is configured to interact with a Lawful interception system. An Intercepting Control Element, ICE, 160 is adapted to interact with the RFID Manager 124 by intercepting for dynamic and optionally static things data related to one or more target identities. Further, the LI system comprises an IMDU 154 comprising an ADMF 158 and a MF2/DF2 162. The exemplary LI system comprises also a Law Enforcement Management Function, LEMF, 152 for requesting LI services of the LI system and collecting the intercepted information of Intercepting Control Elements (ICEs) in the system.

The system shall provide access to the intercepted Content of Communications (CC) and Intercept Related Information (IRI) of a mobile target and services related to the target on behalf of one or more Law Enforcement Agencies (LEAs).

An intercept request, also denoted Request for LI activation, is sent through a first Handover Interface, HI1, located between the Law Enforcement Management Function 152 and an Intercept Mediation and Delivery Unit, IMDU 154 comprising a Mediation Function/Delivery Function, MF2/DF2, 162 and an Administration Function, ADMF, 158. Said Mediation Function 162 and Administration Function 158 generates based on said received request a warrant comprising said one or more target identities, and sends said warrant towards an Intercepting Control Element, ICE, 160 via an interface denoted X1. The ICE 160 is according to the illustrated embodiments connected to a RFID Manager 160, from which it intercepts said Content of Communications, CC, and Intercept Related Information, IRI, of a mobile target. Said CC and IRI are network related data. As reference to the standard model, see references 1, 2 and 3, the content of communication is intercepted in the ICE network node and it is based upon duplication of target communication payload without modification. The ICE 160 sends IRI raw data via an interface X2 to a Mediation Function/Delivery Function, MF2/DF2, 162 for IRI reporting. The Mediation Function/Delivery Function, MF2/DF2, 162 generates and delivers to a Collection Functionality, CF, 170 in the LEMF 152, a standardized IRI report based on the received IRI report. Said standardized IRI report is sent over a standardized interface HI2 to the LEMF 152.

The delivery functions are used to distribute the Intercept Related Information (IRI) to the relevant LEA(s) via HI2.

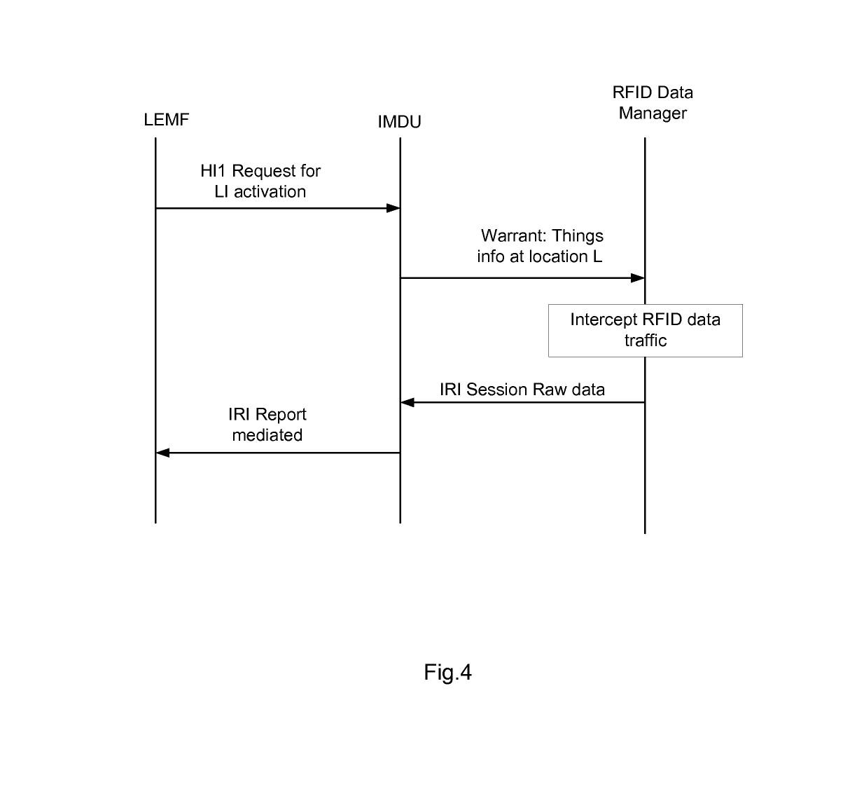

FIG. 4 is a message flow chart illustrating embodiments of the flow of data information in the system and network arrangement.

The Law Enforcement Management Function unit, LEMF, 152 is configured to send a request, i.e. a request for Lawful Interception (LI) activation, for intercepting RFID data traffic through the enhanced RFID Data Manager 124 comprising an Intercepting Control Element, ICE, 160. The request specifies one or more target things as one or more target identities. The request for information may concern different issues, e.g. status of moving things and objects of specified target things or missing target objects in a specific location. The intercept request is sent through the first Handover Interface, HI1, located between the LEMF 152 and the Intercept Mediation and Delivery Unit, IMDU, 154 comprising the Administration Function, ADMF, 158.

In the next node, the IMDU 154 is adapted to receive the request specifying one or more target things or target objects as one or more target identities. When the request for LI activation is received, a warrant is generated by the ADMF 158 based on said one or more target identities. The ADMF 158 is further configured to send said warrant towards an Intercepting Control Element in a Radio-Frequency Identification (RFID) Data Manager via the interface X1. The request may comprise a single warrant requesting for things data information related to static data information of said one or more target identities according to Electronic Product Code (EPC).

In the ICE 160 in the RFID Data Manager 124, said ICE 160 is configured to receive the warrant specifying one or more target things or target objects as one or more target identities. The ICE 160 may also comprise a controller comprising a processor unit, which is configured to intercept the RFID data traffic through the node using said one or more target identities. The ICE 160 is further configured to generate an Intercept Related Information (IRI) report comprising information related to said one or more target identities of said warrant. The ICE 160 is also configured to deliver the IRI report to the node comprising IMDU 154 via the interface X2.

The IMDU 154 comprises a Delivery Function for IRI reporting, DF2, 64 and a Mediation Function of IRI, MF2, 62 that generates and delivers to the LEMF 152 a standardized IRI report based on the received IRI report, which comprises information related to said one or more target identities defined in a warrant. Said standardized IRI report is sent over a standardized interface HI2 to the LEMF 152. When generating said standardized IRI report related to a target identity, at least corresponding thing or object static or dynamic data information is inserted. The report comprises things data information related to dynamic data information of said one or more target identities.

The second Handover Interface, HI2, has been configured to forward an IRI report, e.g. comprising at least one of the following things data:
Organizational Data (business category, . . . );
Full Name;
Timestamp for thing production;
Timestamp for last upgrade.

The LEMF 152 is adapted to receive the standardized IRI report with things data information related to said one or more target identities. Said information is provided to the requesting Law Enforcement Agency (LEA).

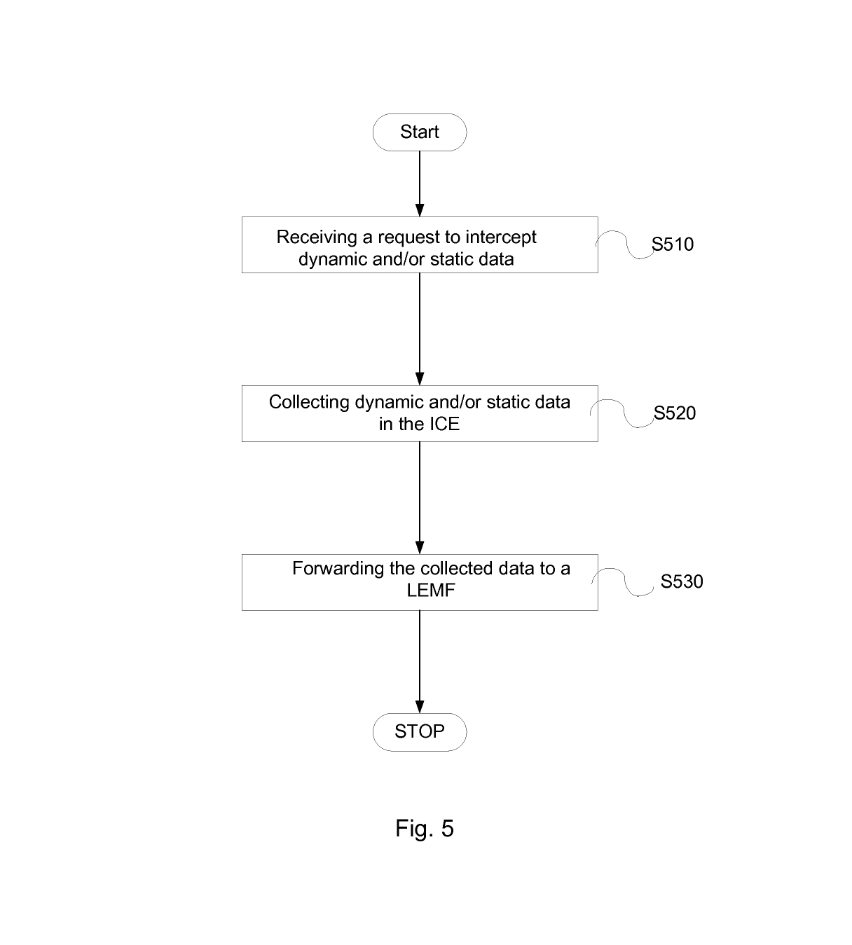

FIG. 5 is a flow chart illustrating embodiments of a method for providing a Law Enforcement Agency with things data related to one or more target identities.

The Radio-Frequency Identification Data Manager is provided with a Intercepting Control Element, ICE, and is thereby configured to act as an ICE of Lawful Intercept system and network in embodiments of the present arrangement 100.

In a first step, S510, the ICE 160 of the arrangement is configured to receive a request to intercept dynamic things data, and optionally, static things data, related to one target identity or more target identities. The request may involve a single warrant requesting dynamic and static things data using an Electronic Product Code (EPC) for target identities.

In the next step, S520, the ICE 160 of the arrangement is configured to collect dynamic things data, and optionally, static things data, related to one target identity or more target identities.

In step S530, the ICE 160 of the arrangement is configured to forward the collected data to a Law Enforcement Management Function, LEMF, 152.

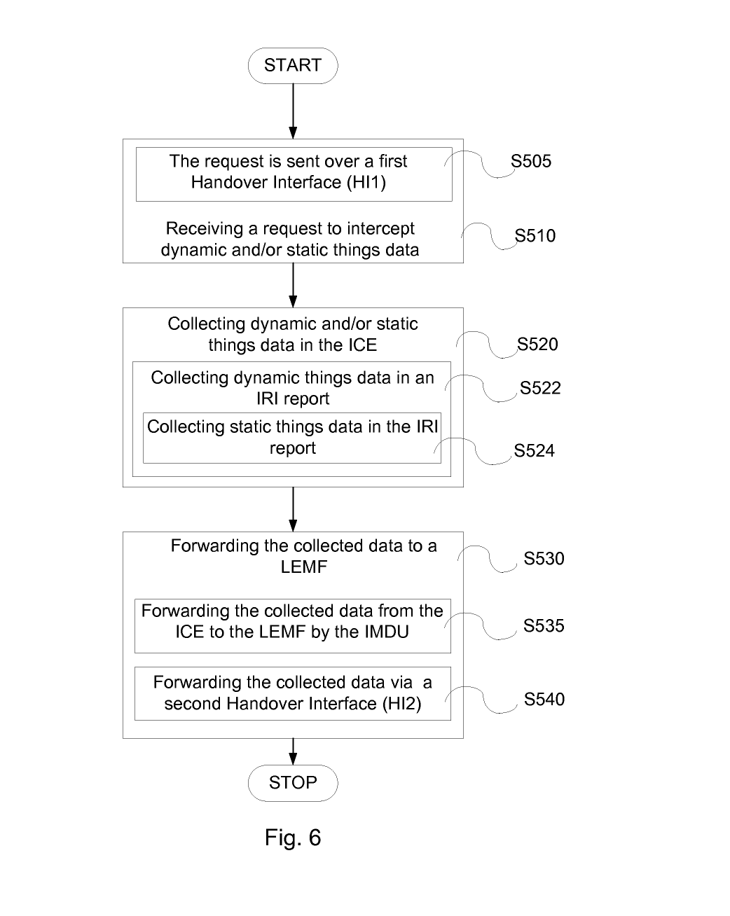

FIG. 6 is a flow chart illustrating other embodiments of a method for providing a Law Enforcement Agency with things data related to one or more target identities.

In step S505, a request is sent through a first Handover Interface (HI1) located between the Law Enforcement Management Function, LEMF, 152 and the Intercept Mediation and Delivery unit, IMDU, 154.

In step, S510, the ICE 160 is configured to receive a request to intercept dynamic things data, and optionally, static things data, related to one target identity or more target identities.

Next, S520, the ICE 160 of the arrangement is configured to collect dynamic things data, and optionally, static things data, related to one target identity or more target identities.

In step S522, the ICE is collecting dynamic things data into an Intercept Related Information, IRI, report. When all requested data is entered into the report, it will be sent to the IMDU 154.

If it is specified in the request to intercept for both dynamic things data and static things data, related to one target identity or more target identities, the optional step 524 is executed, wherein static things data is also collected into the IRI report upon the reception of the single warrant.

In step S530, the ICE 160 of the arrangement is configured to forward the collected things data to a Law Enforcement Management Function, LEMF, 152.

In step S535, the collected things data from the Intercepting Control Element is forwarded by an Intercept Mediation and Delivery Unit, IMDU, 154, to the LEMF 152.

In step 540, the requested things data are forwarded by the IMDU 154 to the LEMF, 152, via a second Handover Interface (HI2).

The alternative embodiments of the method presented in FIGS. 5 and 6 may be implemented for collecting things data in a number of different cases or situations. The described methods and arrangements allow Lawful Enforcement Agency investigators to get all RFID data traffic and relevant things data related to target identities. Two implementations of special interest are:
Lawful Interception of missing things/objects;
Automatic things info triggering.
   These two examples is described in more detail hereafter.

### A. Lawful Interception of Missing Objects

The following described implementation is used for identifying missing things or objects at a location L. The location may be any place e.g. a store, warehouse, library, factory, etc. A set of things or objects is known to be complete in/at a previous location L−1 at a time T. The question is if the set is still complete at the location L, and if the set is not complete, which thing or things are missing.

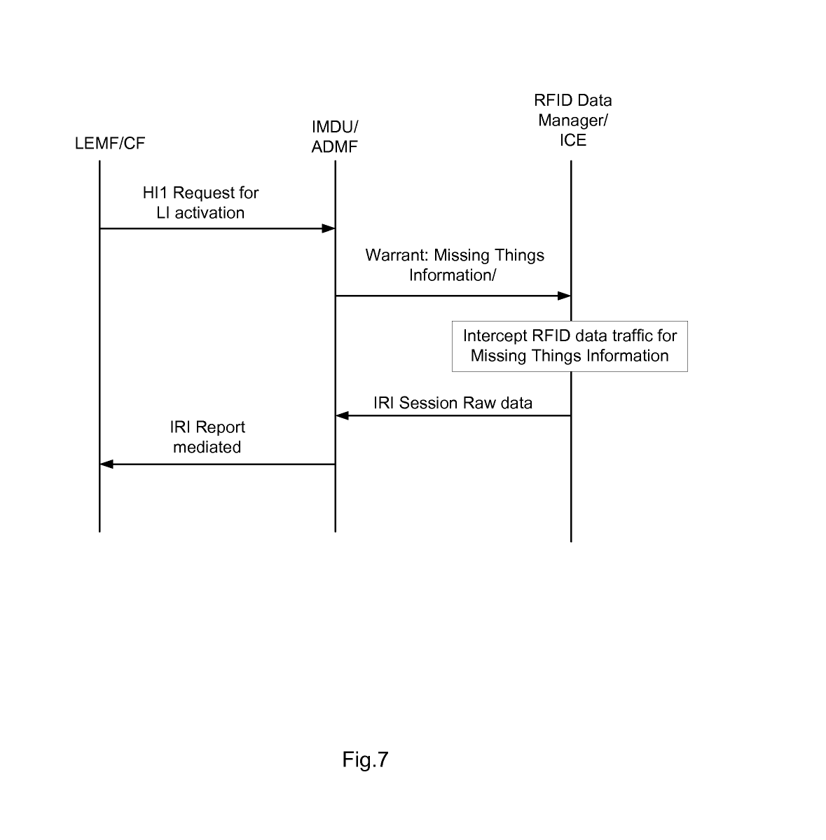

FIG. 7 is a message flow chart illustrating embodiments of the flow of data information in the system and network arrangement which is configured to identifying missing things or objects at a location L. For achieving the described purpose, any embodiment of the described system and network arrangement 100 comprising a mobile RFID data system interacting with a LI system in FIG. 3 may be used. Therefore, in the description hereafter, reference is also made to FIG. 3.

A user, e.g. an investigator of a Law Enforcement Agency, LEA, uses the Law Enforcement Management Function, LEMF, 152 to send a request for intercepting RFID data traffic, i.e. a request for Lawful Interception (LI) activation, through the enhanced RFID Data Manager 124. The request specifies one or more target things as one or more target identities which were present at a previous location L−1 (not shown) at a time T. The intercept request is sent through the first Handover Interface, HI1, located between the LEMF 152 and the Intercept Mediation and Delivery Unit, IMDU, 154 comprising the Administration Function, ADMF, 158. Thus, the request involves a request to get “missing things information”, i.e. get things details associated with the target identity currently under inspection.

The ADMF is configured to activate and send warrants specifying one or more target things as one or more target identities which were present at a previous location L−1 (not shown) at a time T. The warrant triggers the enhanced RFID Data Manager 124 to tap, or collect, i.e. intercept and filter the data traffic for things data records between the RFID data servers 22 and the mobile communication device 14 comprising the RFID reader/sensor 12.

The ICE 160 of the enhanced RFID data manager is configured to receive the warrant specifying one or more target things or target objects as one or more target identities. The ICE 160 may also comprise a controller comprising a processor unit, which is configured to intercept the RFID data traffic through the node using said one or more target identities. Said RFID data traffic may comprise following information, which may be included in specific fields related to RFID things data records:
EPC identification (as represented in the header of the thing data record);
Location identification;
Missing flag (indicating that an object is missing);
Time in (Timestamp indicating when an object enters the identified location);
Time out (Timestamp indicating when an object leaves the identified location).

For enabling the identification, the ICE has to be configured to store things data record for the set of things or objects in question and which is known to be complete in/at a previous location L−1 at a time T. Said set of objects 18 may be identified as the complete set S_{comp}(obj.1; obj.2; obj.3). When the things data records for the set S_{L}(obj.1; obj.2; obj.3) of things/objects at a new location L are collected, the ICE 160 is configured to compare the things data records of the two sets. If a difference is indicated, at least one of the things is missing. Said object(-s) is/are identified and the things data information is collected and stored.

The ICE 160 is further configured to generate an Intercept Related Information (IRI) report comprising information related to said one or more missing things, i.e. target identities, requested for in said warrant. The ICE 160 is also configured to deliver the IRI report to the node comprising IMDU 154 via the interface X2.

The IMDU 154 comprises a Delivery Function for IRI reporting, DF2, 64 and a Mediation Function of IRI, MF2, 62. The MF2/DF2 converts the received things data into the required format a standardized IRI report based on the received IRI report, which comprises information related to said one or more target identities defined in the warrant and found to be missing. Said standardized IRI report is sent over a standardized interface HI2 to the LEMF 152. When generating said standardized IRI report related to a target identity, at least corresponding thing or objection dynamic and/or static data information is inserted.

The second Handover Interface, HI2, has been configured to forward an IRI report, e.g. comprising at least one of the following things data:
Organizational Data (business category, . . . );
Full Name;
Timestamp for thing production;
Timestamp for last upgrade.

The LEMF 152 may comprise a Collection Functionality, CF, 170 is adapted to receive the standardized IRI report with things data information related to said one or more target identities. Said information is provided to the requesting Law Enforcement Agency (LEA).

### B. Automatic Things Information Triggering.

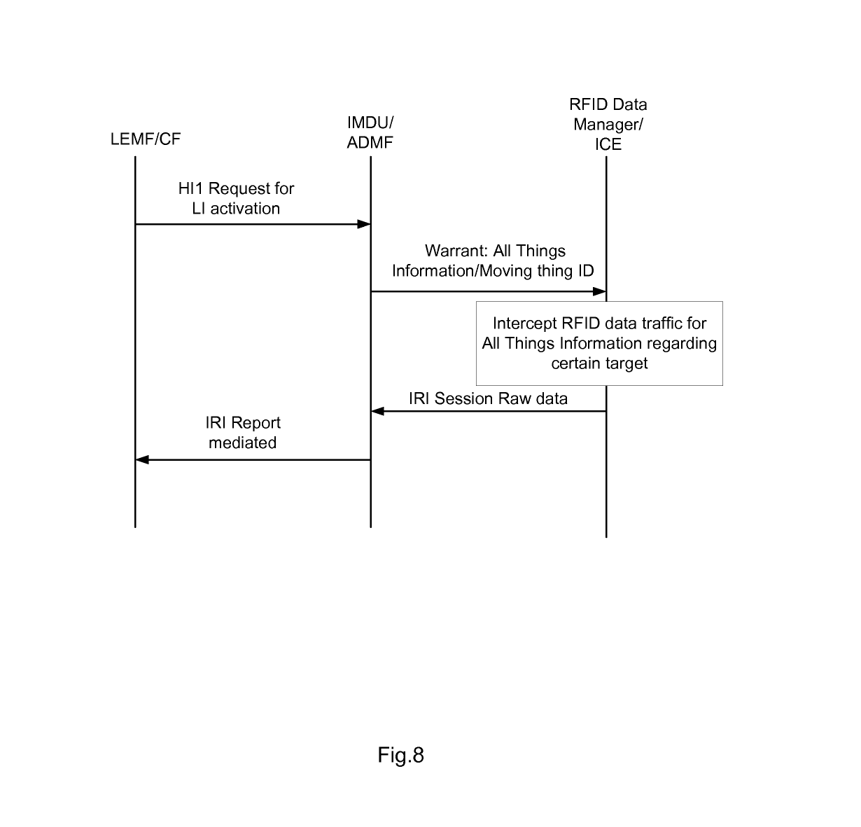

FIG. 8 is a message flow chart illustrating embodiments of the flow of data information in the system and network arrangement which is configured to activate an automatic triggering warrant towards things information, when a target, i.e. object/thing/item, under monitoring moves in a specified location L. For achieving the described purpose, any embodiment of the described system and network arrangement 100 comprising a mobile RFID data system interacting with a Lawful Interception, LI, system in FIG. 3 may be used. Therefore, in the description hereafter, reference is also made to FIG. 3.

A user, e.g. an investigator of a Law Enforcement Agency, LEA, uses the Law Enforcement Management Function, LEMF, 152 to send a request for intercepting RFID data traffic, i.e. a request for Lawful Interception (LI) activation, through the enhanced RFID Data Manager 124. The request specifies one or more target things as one or more target identities which moves in a location L. The intercept request is sent through the first Handover Interface, HI1, located between the LEMF 152 and the Intercept Mediation and Delivery Unit, IMDU, 154 comprising the Administration Function unit, ADMF, 158. Thus, the request involves a request to get “all things information”, i.e. get things details associated with the target identity currently under inspection.

The ADMF 158 is configured to send warrants for activation and automatic triggering when one or more target things under inspection moves in a location L.

The ICE 160 of the enhanced RFID data manager 124 is configured to receive the warrant. The ICE 160 may comprise a controller comprising a processor unit, which is configured to intercept the RFID data traffic through the node using said one or more target identities. The ICE and the enhanced RFID Data Manager 124 are triggered by the warrant to tap, or collect, i.e. intercept and filter the data traffic for things data records sent between the RFID data servers 22 and the mobile communication device 14 comprising the RFID reader/sensor 12. The RFID readers 12 in a location L is activated and when a target object moves, the RFID system is triggered to send things data records between the mobile RFID communication device 14 and the RFID data servers 22. Said RFID data traffic may comprise following information, which may be included in specific fields related to RFID things data records:
EPC identification (as represented in the header of the thing data record);
Location identification;
Time in (Timestamp indicating when an object enters the identified location);
Time out (Timestamp indicating when an object leaves the identified location).

The ICE 160 is further configured to generate an Intercept Related Information (IRI) report comprising collected information related to said one or more moving target objects/things, i.e. target identities, requested for in said warrant. The ICE 160 is also configured to deliver the IRI report to the node comprising IMDU 154 via the interface X2.

The IMDU 154 comprises a Delivery Function for IRI reporting, DF2, 64 and a Mediation Function of IRI, MF2, 62. The MF2/DF2 converts the received things data into the required format a standardized IRI report based on the received IRI report, which comprises information related to said one or more target identities defined in the warrant and found to be moving in the location. Said standardized IRI report is sent over a standardized interface HI2 to the LEMF 152. When generating said standardized IRI report related to a target identity, at least corresponding thing or objection dynamic and/or static data information is inserted.

The second Handover Interface, HI2, has been configured to forward an IRI report, e.g. comprising any of the following things data:
Organizational Data (business category, . . . );
Full Name;
Timestamp for thing production;
Timestamp for last upgrade;
EPC identification (as represented in the header of the thing data record);
Location identification;
Time in (Timestamp indicating when an object enters the identified location);
Time out (Timestamp indicating when an object leaves the identified location).

The LEMF 152 may comprise a Collection Functionality, CF, 170 is adapted to receive the standardized IRI report with things data information related to said one or more target identities. Said information is provided to the requesting Law Enforcement Agency (LEA).

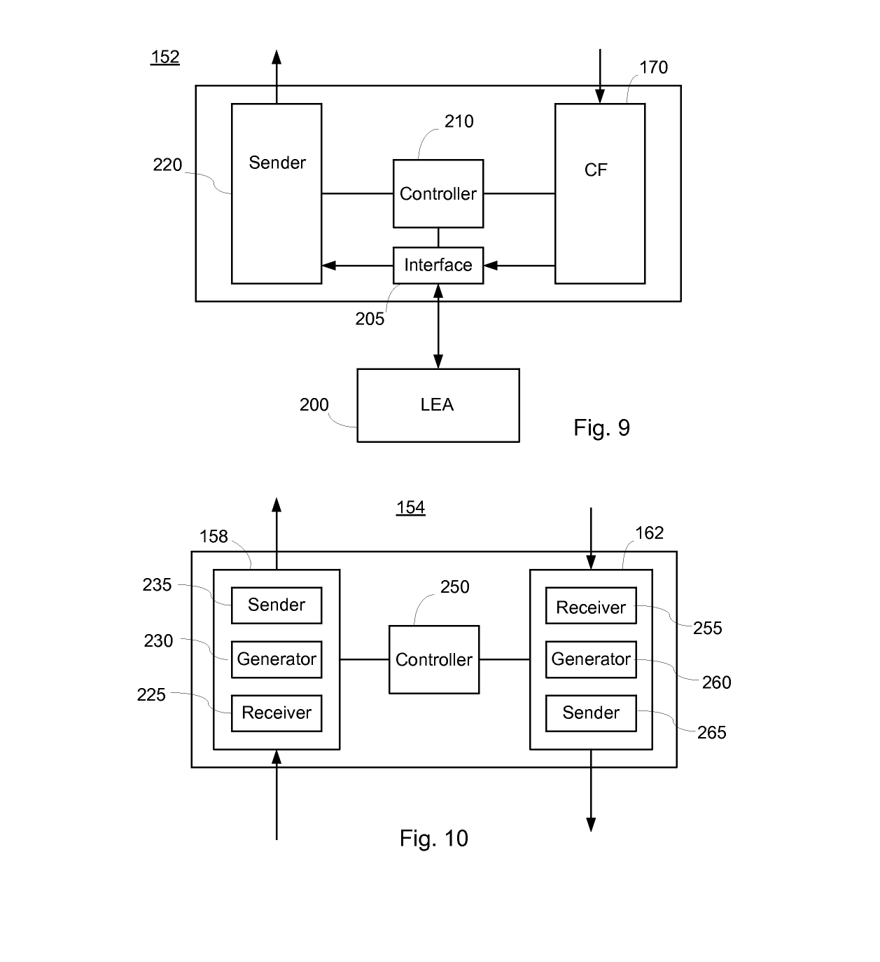

FIG. 9 is a block diagram illustrating an embodiment of a Law Enforcement Management Function unit, LEMF. The Law Enforcement Management Function, LEMF, 152 of the arrangement comprises a sender 220, which sends a request for intercepting RFID data traffic through the RFID Data Manager System over the HI1 interface to an IMDU 154. Said request is processed in the IMDU 154 and sent towards the Radio-Frequency Identification (RFID) Data Manager 124 comprising the Intercepting Control Element (ICE) 160. The request specifies one or more target things as one or more target identities. It further comprises a Collecting Functionality unit, CF, 170 configured to receive a report over the HI2 interface with things data information related to said one or more target identities, said information being a result of an interception of the RFID data traffic. The Sender 220 and the CF 170 is connected to controller 210, which is communicating with the sender and the CF. It also communicates with an input and output interface 205. Said interface connects the LEMF 152 with one or more Law Enforcement Agencies 200. The LEMF 152 communicates with the LEA, e.g receives requests for interceptions and delivers reports as a result of said requests.

FIG. 10 is a block diagram illustrating an embodiment of an Intercept Mediation and Delivery Unit, IMDU. The IMDU 154 of the arrangement comprises a controller 250 in a processor unit. Said controller is configured to control the Administration Function unit, ADMF, 158, and the Delivery Function for IRI reporting, DF2, and a Mediation Function of IRI, MF2, 162, here denoted MF/DF.

The ADMF 158 comprises a receiver 225 that receives a request for LI activation from the LEMF 152 over the interface HI1. Said request specifies one or more target things or target objects as one or more target identities. The ADMF 158 further comprises a request/warrant generator 230 that generates based on said received request for LI activation a warrant comprising said one or more target identities. The generating of a warrant is activated by the received request for LI activation comprising a request for information regarding moving things and objects of specified target things or target objects in a specific location. The received request for LI activation may comprise a request for information regarding missing things or objects of specified target things or target objects at a specific location. The request/warrant generator forwards said request comprising a warrant to a sender block 235 that sends request with the warrant towards an Intercepting Control Element in a Radio-Frequency Identification (RFID) Data Manager System.

The MF/DF 162 comprises a report receiver 255, a report generator 260 and a report sender 265. The report receiver 255 receives from the RFID data manager 124 with the ICE 160 an Intercept Related Information (IRI) report comprising information related to one or more target identities. The report generator 260 generates a standardized IRI report based on the received IRI report. When generating said standardized IRI report related to a target identity, at least corresponding thing or objection static or dynamic data information is inserted. The report sender 265 is configured to send and deliver over the interface HI2 said standardized IRI report to a Collection Functionality unit, CF, 170 of a receiving LEMF 152.

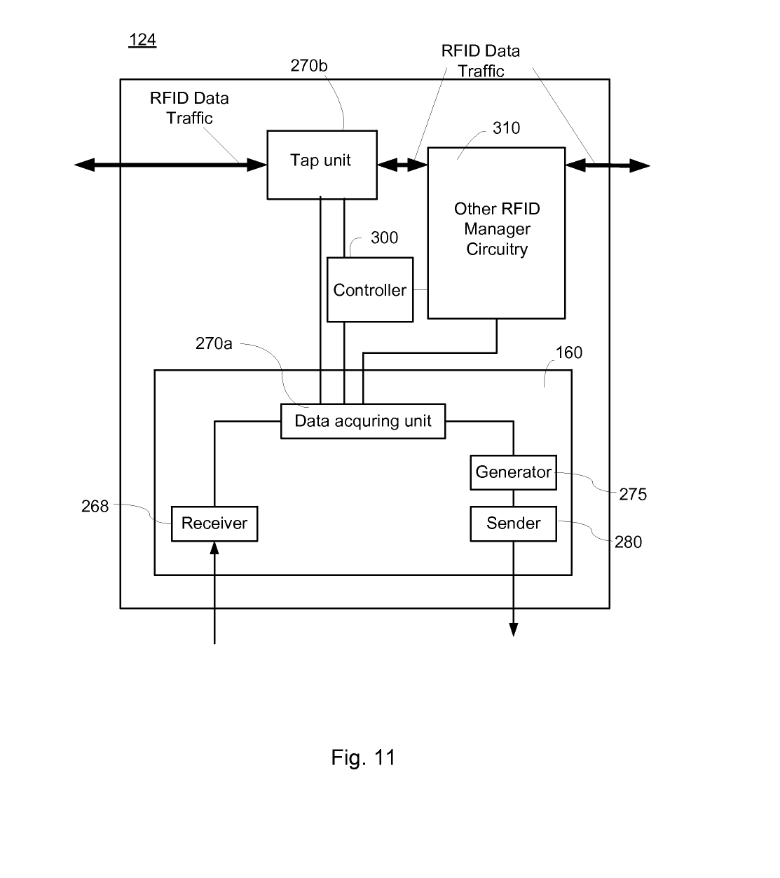

FIG. 11 is a block diagram illustrating an embodiment of a RFID manager comprising an Intercept Controller Element.

In the Radio-Frequency Identification (RFID) Data Manager 124 comprises an Intercepting Control Element ICE 160 and other RFID Manager Circuitry 310. Said RFID data manager comprises a controller 300 comprising a processor unit configured to control the circuitry, units, blocks and functionalities of the Intercepting Control Element, ICE, 160 and other RFID Manager Circuitry 310.

The ICE 160 is provided with a receiver unit to receive a request with a warrant specifying one or more target things or target objects as one or more target identities. The request is an order to intercept RFID Data Traffic passing through the RFID Data Manager for dynamic and optionally static things data related to said one or more target identities. The RFID Data traffic is the things data traffic, or communication between the RFID Data Servers and the mobile communication devices. The ICE 160 is therefore provided with data acquiring means 270a, 270b comprising a data acquiring unit 270a and a tap unit 270b for intercept RFID data traffic through the node using said one or more target identities. The data acquiring unit 270a collects the tapped data and forwards it to an ICE IRI-generator 275 that generates an Intercept Related Information (IRI) report comprising information related to said one or more target identities of said warrant. The ICE IRI-generator 275 delivers the generated IRI report to a ICE sender 280, which sends the IRI report to a Intercept Mediation and Delivery Unit, IMDU, 154.

Thus the ICE 160 is configured to collect dynamic things and optionally static things data related to one or more target identities for which things data has been requested. The sender adapted to forward the collected things data to an IMDU 154, who processes the data. Such a process may be filtering and conversion of the data to another format or standard. The processed data is delivered to a Law Enforcement Management Function 152 for further distribution to the requesting LEA 200.

The data acquiring means 270a, 270 b are configured to intercept the RFID data traffic through the manager for information regarding:
a target thing or target object using a location identity of the location of a target identity, which is specified in the received warrant; or
a target thing or target object using a time when a specified target thing or object enters or leaves a location, which time and location are specified in the received warrant; or
missing things or objects of specified target things or target objects at a specific location, which target things or target objects and location are specified in the received warrant; or
moving things and objects of specified target things or target objects in a specific location, which target things or target objects and location are specified in the received warrant.

The invention may be implemented in digital electronically circuitry, or in computer hardware, firmware, software, or in combinations of them. Apparatus of the invention may be implemented in a computer program product tangibly embodied in a machine readable storage device for execution by a programmable processor; and method steps of the invention may be performed by a programmable processor executing a program of instructions to perform functions of the invention by operating on input data and generating output.

The described entities, i.e. LEMF 152, IMDU 154, RFID 124 with ICE 160, may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language if desired; and in any case, the language may be a compiled or interpreted language.

Generally, a processor, e.g. in a controller, will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially—designed ASICs (Application Specific Integrated Circuits).

A number of embodiments of the present invention have been described. It will be understood that various modifications may be made without departing from the scope of the invention. Therefore, other implementations are within the scope of the following claims defining the invention.

### REFERENCES

[1] 3GPP TS 33.106 “Lawful Interception requirements (Release 8)”
[2] 3GPP TS 33.107 “Lawful interception architecture and functions (Release 8)”
[3] 3GPP TS 33.108 “Handover interface for Lawful Interception” (Release 8)
[4] COMMUNICATION FROM THE COMMISSION TO THE EUROPEAN PARLIAMENT, THE COUNCIL, THE EUROPEAN ECONOMIC AND SOCIAL COMMITTEE AND THE COMMITTEE OF THE REGIONS Radio Frequency Identification (RFID) in Europe: steps towards a policy framework http://ec.europa.eu/information_society/policy/did/documents/infso_com_{—}2007_{—}96.pdf
[5] System Framework and its application in Mobile RFID Service Network
[6] Warehousing and Analyzing Massive RFID Data Sets, University of Illinois at Urbana-Champaign, Urbana, Ill. 61801, USA

1-19. (canceled)

20. A method for providing a Law Enforcement Agency with things data related to one or more target identities using a Radio-Frequency Identification (RFID) Data Manager, which manages RFID data traffic comprising things data in a Radio-Frequency Data system, wherein said RFID manager is provided with an Intercepting Control Element (ICE), the method comprising:
receiving, at the ICE, a request to intercept dynamic and optionally static things data related to one or more target identities;
collecting, in the ICE, the dynamic things and optionally static things data related to the one or more of the target identities for which things data has been requested; and
forwarding the collected data to a Law Enforcement Management Function (LEMF) unit.

21. The method according to claim 20, wherein collecting the dynamic things data comprises collecting the dynamic things data in an Intercept Related Information (IRI) report upon receiving the request to intercept the dynamic things data.

22. The method according to claim 20, wherein the request further comprises a single warrant requesting the dynamic and optionally static things data using the Electronic Product Code (EPC) for the one or more target identities.

23. The method according to claim 22, further comprising adapting the request and the single warrant for ordering the ICE to collect missing things data, said warrant activating one or more target things identified to be missing in a specified location.

24. The method according to claim 22, further comprising adapting the request and the single warrant for ordering the ICE to collect moving things data.

25. The method according to claim 20, wherein receiving the request comprises receiving the request through a first Handover Interface (HI1) located between the LEMF unit and an Intercept Mediation and Delivery Unit communicatively coupled to the ICE in a Lawful Interception (LI) Network.

26. The method according to claim 25, wherein forwarding the collected data comprises forwarding the collected data from an Intercept Mediation and Delivery Unit communicatively coupled to the ICE to the LEMF unit via a second Handover Interface (HI2) in the Lawful Interception (LI) Network.

27. The method according to claim 26, wherein the second Handover Interface (HI2) is configured to forward an Intercept Related Information (IRI) report comprising at least one of the following things data:
EPC identification;
Location identification;
Time in; and
Time out.

28. An Intercepting Control Element (ICE) in a Radio-Frequency Identification (RFID) Data Manager adapted to provide a Law Enforcement Agency with dynamic things data and optionally static things data related to one or more target identities, wherein said RFID Data Manager manages RFID data traffic comprising things data in a Radio-Frequency Data system, wherein said ICE comprises:
a receiver to receive a request to intercept dynamic and optionally static things data related to one or more target identities;
a data acquiring unit configured to collect the dynamic things and optionally static things data related to one or more of the target identities for which things data has been requested; and
a sender to forward the collected things data to a Law Enforcement Management Function unit.

29. The ICE according to claim 28, wherein the request further comprises a single warrant requesting collection of the dynamic and optionally static things data related to the one or more target identities.

30. The ICE according to claim 28, wherein said receiver is configured to receive said request through a first Handover Interface (HI1) located between the Law Enforcement Management Function unit and an Intercept Mediation and Delivery Unit communicatively coupled to the ICE.

31. The ICE according to claim 28, wherein the sender is configured to forward the requested data from the ICE to the Law Enforcement Management Function unit by an Intercept Mediation and Delivery Unit via a second Handover Interface (HI2).

32. The ICE according to claim 31, wherein the second Handover Interface (HI2) is configured to forward an Intercept Related Information (IRI) report comprising at least one of the following things data:
EPC identification;
Location identification;
Time in; and
Time out.

33. A Law Enforcement Management Function (LEMF) unit comprising:
a sender to send a request for things data to an Intercepting Control Element (ICE); and
a collection functionality unit to receive at least one of dynamic things data and static things data.

34. The LEMF unit according to claim 33, wherein the sender is configured to send the request via a first Handover Interface (HI1) located between the LEMF unit and an Intercept Mediation and Delivery Unit communicatively coupled to the ICE in a Lawful Interception (LI) Network.

35. The LEMF unit according to claim 33, wherein the collection functionality unit is configured to receive at least one of the dynamic things data and the static things data from an Intercept Mediation and Delivery Unit via a second Handover Interface (HI2) in a Lawful Interception (LI) Network.

36. A Radio-Frequency Identification (RFID) Data Manager, which manages things data traffic in a Radio-Frequency Data system, wherein said RFID manager comprises an Intercepting Control Element (ICE) of a Lawful Interception (LI) Network, said ICE configured to provide a Law Enforcement Agency with at least one of dynamic things data and static things data related to one or more target identities responsive to a received request for things data.

37. The RFID Data Manager according to claim 36, wherein the ICE comprises a data acquiring unit configured to collect at least one of the dynamic things data and static things data related to the one or more target identities from a things data traffic ordered by the received request.

38. A computer program product comprising non-transient computer program code loadable into a processor, wherein when executed in the processor the computer program code is configured to execute a method for providing a Law Enforcement Agency with things data related to one or more target identities using a Radio-Frequency Identification (RFID) Data Manager, which manages RFID data traffic comprising things data in a Radio-Frequency Data system, wherein said RFID manager is provided with an Intercepting Control Element (ICE), wherein the method executed by the processor comprises:
receiving, at the ICE, a request to intercept dynamic and optionally static things data related to one or more target identities;
collecting, in the ICE, dynamic things and optionally static things data related to the one or more of the target identities for which things data has been requested; and
forwarding the collected data to a Law Enforcement Management Function (LEMF) unit.
